(19) United States
(12) Patent Application Publication
(10) Pub. No.: US 2026/0203574 A1
(43) Pub. Date: Jul. 16, 2026

(54) NEURAL NETWORK LEARNING METHOD FOR PERFORMING EXPERIENCE REPLAY FOR ONLINE CONTINUOUS LEARNING USING SIGMA POINT-BASED MEMORY CONSTRUCTION AND COMPUTING DEVICE FOR PERFORMING SAME

(71) Applicant: CHUNG ANG UNIVERSITY INDUSTRY ACADEMIC COOPERATION FOUNDATION, Seoul (KR)

(72) Inventors: JONG WON CHOI, Gyeongsangnam-do (KR); SEUNG MO SEO, Seoul (KR)

(21) Appl. No.: 19/424,903

(22) Filed: Dec. 18, 2025

(30) Foreign Application Priority Data
Jan. 10, 2025 (KR) 10-2025-0004278

(51) Int. Cl. G06N 3/08; G06N 3/0455

(52) U.S. Cl. CPC G06N 3/08; G06N 3/0455

(57) ABSTRACT

A neural network learning method is for performing experience replay for online continuous learning using a sigma point-based memory construction. A neural network learning method includes receiving n-th batch data for the online continuous learning, inputting the received n-th batch data into a feature extractor to extract n-th feature data, calculating a sigma point for the extracted n-th feature data in a latent space by inputting the n-th feature data into a variational autoencoder, and storing data closest to the sigma point calculated from the n-th feature data in a memory buffer. Data stored in a memory buffer can be more efficiently selected through sigma point-based memory construction, and experience replay for online continuous learning that can learn with new data can be performed.

### CROSS-REFERENCE TO RELATED APPLICATION AND CLAIM OF PRIORITY

This application claims the benefit under 35 USC § 119 of Korean Patent Application No. 10-2025-0004278, filed on Jan. 10, 2025, in the Korean Intellectual Property Office, the entire disclosure of which is incorporated herein by reference for all purposes.

### BACKGROUND

### 1. Technical Field

The technical field to which the present disclosure belongs relates to a neural network learning technology that more efficiently selects data to be stored in a memory buffer through a sigma point-based memory construction and performs experience replay for online continuous learning that can learn with new data.

### 2. Description of Related Art

Continuous learning means that an artificial intelligence model can learn multiple tasks sequentially, while continuously learning new tasks without forgetting previously learned information. In existing continuous learning techniques, most experience replay methods adopt an approach that stores data in a memory buffer through random sampling.

While this random sampling method may seem simple and intuitive, it has limitations in online continuous learning. That is, the existing method has the problem of failing to properly reflect the distribution of previously learned data.

The data that neural networks learn from each has its own distribution, and randomly selected samples fail to adequately represent the distribution of the entire dataset. In particular, in online continuous learning, only small-sized memory buffers are allowed, so the difference between the distribution of a small number of randomly selected samples and the distribution of the entire data is even more severe. This difference in distribution increases the risk of overfitting in neural networks.

The content described in this section is provided solely to give background information on the present embodiment and does not constitute prior art.

Examples of related art include Korean patent registration No. 10-2399533.

### SUMMARY

Embodiments of the present disclosure provide a neural network learning method for performing experience replay for online continuous learning using a sigma point-based memory construction that can well reflect the distribution of previous learning data, and a computing device for performing the same.

According to an embodiment of the present disclosure, there is provided a neural network learning method performed on a computing device including one or more processors, a memory that stores one or more programs executed by the one or more processors, and a neural network for online continuous learning, the neural network learning method including receiving n-th batch data for the online continuous learning, inputting the received n-th batch data into a feature extractor to extract n-th feature data, calculating a sigma point for the extracted n-th feature data in a latent space by inputting the n-th feature data into a variational autoencoder, and storing data closest to the sigma point calculated from the n-th feature data in a memory buffer.

The neural network learning method may further include inputting n-th data stored in the memory buffer and (n+1)-th batch data into the feature extractor to extract (n+1)-th feature data, calculating a sigma point for the (n+1)-th feature data in the latent space by inputting the (n+1)-th feature data into the variational autoencoder, and storing data corresponding to the sigma point calculated from the (n+1)-th feature data in the memory buffer.

The neural network learning method may further include inputting n-th data stored in the memory buffer and (n+1)-th batch data input into the feature extractor to extract (n+1)-th feature data, and then inputting the (n+1)-th feature data into a classifier to predict a class of the (n+1)-th batch data.

The calculating of the sigma point may include training the variational autoencoder, and in the training of the variational autoencoder, the variational auto-encoder may be trained by a preset loss function that allows a distribution of a latent variable of the variational auto-encoder for the feature data to be approximated as a Gaussian distribution.

The loss function may be set by a reconstruction loss function of the variational autoencoder and a KL divergence loss function based on a mean and variance of the feature data.

The KL divergence loss function may be expressed by Equation 1 below.

$${L}_{KL} = - 0.5 * {\sum }_{j = 1}^{n} ( 1 + log ( {σ}_{B , j}^{2} ) - {μ}_{B , j}^{2} - {σ}_{B , j}^{2} ) \qquad Equation 1$$

μ_{B,j}: mean of j-th dimension of feature data in batch unit

$${σ}_{B , j}^{2}$$

variance of j-th dimension of feature data in batch unit
n: the number of dimensions in latent space
j: indicator representing specific dimension in covariance matrix

The loss function may be expressed by Equation 2 below.

$${L}_{i} ( {θ}_{VAE} ; {B}_{i} ) = {\sum }_{b ∈ {B}_{i}} {L}_{recon} ( b , {b}_{recon} ) + β * {L}_{KL} \qquad Equation 2$$

Bᵢ: batch data
b: sample data belonging to batch data
L_recon(b,b_{recon}): reconstruction loss
β: hyperparameter
L_{KL}: KL divergence loss function

The sigma point may include a first sigma point calculated using the mean of the latent space distribution approximated as the Gaussian distribution, and a second sigma point and a third sigma point each calculated using the mean and covariance of the latent space distribution approximated as the Gaussian distribution.

The first sigma point to the third sigma point may be calculated using Equation 3 below.

$${χ}_{m}^{i} = {μ}_{i} , \qquad Equation 3$$

$${χ}_{j}^{i} = {μ}_{i} + {[ \sqrt{( γ + n ) {\sum }_{i}} ]}_{j} ,$$

$${χ}_{j + n}^{i} = {μ}_{i} - {[ \sqrt{( γ + n ) {\sum }_{i}} ]}_{j}$$

$${χ}_{m}^{j} :$$

first sigma point

$${χ}_{j}^{i} :$$

second sigma point

$${χ}_{j + n}^{i} :$$

third sigma point
j: indicator indicating specific dimension in covariance matrix
n: total number of dimensions in latent distribution
μᵢ: mean of latent space distribution approximated as Gaussian distribution
Σᵢ: covariance of latent space distribution approximated as Gaussian distribution
γ: pre-set hyperparameter

In the storing of the data closest to the sigma point in the memory buffer, data respectively closest to the first sigma point to the third sigma point among the batch data may be extracted and stored in the memory buffer.

The data to be stored in the memory buffer may be extracted using Equations 4-6 below.

$${S}_{m}^{i} = {arg min}_{{x}_{i} ∈ ( {t}_{i} ⋃ {M}_{i} )} {‖ {χ}_{m}^{i} - {z}_{{x}_{i}} ‖}_{2} \qquad Equation 4$$

$${S}_{j}^{i} = {arg min}_{{x}_{i} ∈ ( {t}_{i} ⋃ {M}_{i} )} {‖ {χ}_{j}^{i} - {z}_{{x}_{i}} ‖}_{2} \qquad Equation 5$$

$${S}_{j + n}^{i} = {arg min}_{{x}_{i} ∈ ( {t}_{i} ⋃ {M}_{i} )} {‖ {χ}_{j + n}^{i} - {z}_{{x}_{i}} ‖}_{2} \qquad Equation 6$$

$${S}_{m}^{i} :$$

data closest to first sigma point among batch data.

$${S}_{j}^{i} :$$

data closest to second sigma point among batch data.

$${S}_{j + n}^{i} :$$

data closest to third sigma point among batch data.
zₓ_{ᵢ}: latent variable of data xᵢ
argmin: function that returns position of the smallest value in list or array

According to an embodiment of the present disclosure, there is provided a computing device including a processor, a memory that stores one or more programs executed by the processor, and a neural network for online continuous learning, the processor is configured to perform an operation of receiving n-th batch data for the online continuous learning, an operation of inputting the received n-th batch data into a feature extractor to extract n-th feature data, an operation of calculating a sigma point for the extracted n-th feature data in a latent space by inputting the n-th feature data into a variational autoencoder, and an operation of storing data closest to the sigma point calculated from the n-th feature data in a memory buffer.

The matters described as the means for solving the problems described above are merely illustrative and should not be interpreted as limiting the scope of the present disclosure. In addition to the exemplary embodiments described above, additional embodiments may exist as described in the drawings and the detailed description of the invention.

### BRIEF DESCRIPTION OF THE DRAWINGS

FIG. 1 is a flowchart for describing a neural network learning method for online continuous learning when inputting n-th batch data according to an embodiment.

FIG. 2 is a flowchart for describing a neural network learning method for online continuous learning when inputting (n+1)-th batch data according to an embodiment.

FIG. 3 is an exemplary diagram of a configuration of a neural network learning device according to an embodiment.

FIG. 4 is a diagram for describing extraction of sigma points from a latent distribution according to an embodiment.

FIG. 5 is a block diagram for illustratively describing a computing environment including a computing device suitable for use in exemplary embodiments.

### DETAILED DESCRIPTION

Hereinafter, specific embodiments of the present disclosure will be described with reference to the drawings. The following detailed description is provided to facilitate a comprehensive understanding of the methods, apparatuses, and/or systems described herein. However, this is only an example and the present disclosure is not limited thereto.

In describing embodiments of the present disclosure, if it is determined that a specific description of a related known function of the preset invention may unnecessarily obscure the gist of the present disclosure, the detailed description thereof will be omitted. The terms described below are terms defined in consideration of the functions in the present disclosure, and vary depending on the intention or custom of the user or operator. Therefore, the definition should be made based on the contents throughout this specification. The terminology used in the detailed description is for the purpose of describing embodiments of the present disclosure only and should not be construed as limiting. Unless expressly used otherwise, singular forms include plural forms. In this description, the terms “including” or “comprising” are intended to refer to certain features, numbers, steps, operations, elements, portions or combinations thereof, and should not be construed to exclude the presence or possibility of one or more other features, numbers, steps, operations, elements, portions or combinations thereof other than those described.

In addition, the terms first, second, etc. may be used to describe various components, but the components should not be limited by the terms. The terms may be used for the purpose of distinguishing one component from another component. For example, without departing from the scope of the present disclosure, a first component may be referred to as a second component, and similarly, a second component may also be referred to as a first component.

The present disclosure relates to a neural network learning technology that more efficiently selects data to be stored in a memory buffer using a sigma point-based memory construction and performs experience replay for online continuous learning that can learn with new data.

In this specification, continuous learning may mean that an artificial intelligence model can learn multiple tasks sequentially, while continuously learning new tasks without forgetting previously learned information.

In this specification, online continuous learning may mean a method for performing learning in an environment where data is not provided all at once, but is input sequentially over time.

In this specification, experience replay refers to a method of storing previously learned data in memory to a certain extent in a continuous learning environment and then reusing this stored data when learning new data. Experience replay may be used as an effective method to mitigate the phenomenon of forgetting that occurs during continuous learning.

Hereinafter, embodiments of a neural network learning method and device for performing experience replay for online continuous learning using the sigma point-based memory construction described in detail with reference to drawings.

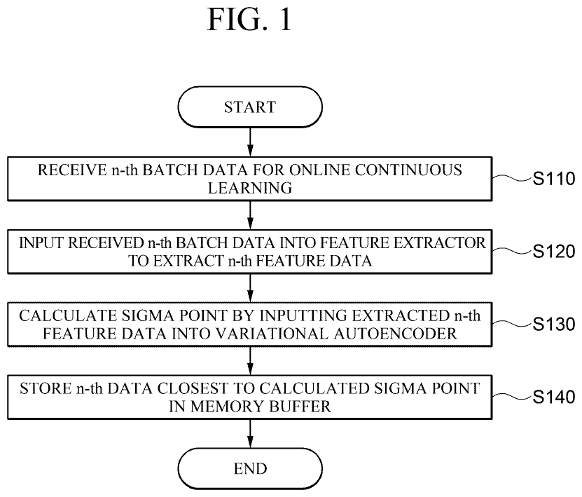

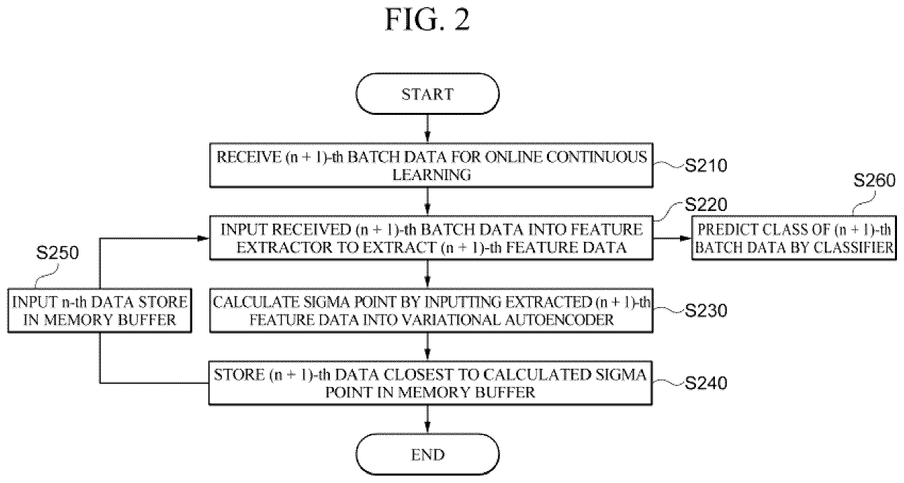

FIGS. 1 and 2 are flowcharts showing the operating method of a computing device that trains a neural network for online continuous learning. FIG. 1 shows the operating method of a computing device when n-th batch data is input, and FIG. 2 shows the operating method of a computing device when (n+1)-th batch data is input.

Referring to FIG. 1, the operating method of a computing device for training learning a neural network for online continuous learning may include receiving n-th batch data for online continuous learning on a computing device (S110), inputting the received n-th batch data into a feature extractor to extract n-th feature data (S120), calculating a sigma point for the extracted n-th feature data in a latent space by inputting the n-th feature data into a variational autoencoder (S130), and storing data closest to the sigma point calculated from the n-th feature data in a memory buffer (S140).

Referring to FIG. 2, the operating method of a computing device for learning a neural network for online continuous learning may include inputting (n+1)-th batch data for online continuous learning into a computing device (S210), inputting n-th feature data stored in the memory buffer into the feature extractor (S250), inputting newly input (n+1)-th batch data (S210) and n-th data stored in the memory buffer (S250) into the feature extractor to extract feature data again (S220), inputting the extracted (n+1)-th feature data into a variational autoencoder to calculate a sigma point (S230), and storing (n+1)-th data closest to the calculated sigma point in the memory buffer (S240).

In addition, inputting the feature data into a classifier to predict a class of the batch data (S260) may be further included.

In the operation of a computing device that trains a neural network for online continuous learning, n means a positive integer starting from 1, such as 1, 2, 3, 4 . . . .

Hereinafter, the operation of each step of FIG. 1 will be described.

In step S110, the computing device may receive n-th batch data for online continuous learning.

Batch data is a subset of data obtained by dividing the entire data into small units for training machine learning or deep learning models. Batch data may be used in computing devices for model training by calculating the mean or variance in units of batches or computing a loss function. Batch data may contain a plurality of sample data that are individual data.

In step S120, the feature extractor may extract feature data by inputting batch data or batch data and memory buffer data into the feature extractor.

As a feature extractor according to an embodiment, a residual neural network (ResNet) may be used. The computing device may apply the existing feature extraction capability to other tasks by adding a new output layer suitable for the feature data by utilizing the pre-trained residual neural network model.

In step S130, the computing device may input the extracted feature data into a variational autoencoder to calculate a sigma point for the feature data in a latent space.

The variational autoencoder is an artificial neural network that models the latent space of data as a probability distribution. The variational autoencoder consists of an encoder that compresses input data into a low-dimensional latent space, and a decoder that restores the original data from that latent space.

Here, the encoder learns the probability distribution by estimating the mean and variance to approximate the latent space of the input data with a Gaussian distribution. After that, the decoder reconstructs the data based on the latent variables extracted from the encoder. During this process, the variational autoencoder performs learning by a loss function to minimize the difference between the reconstruction error and the distribution, and creates a probabilistic structure in the latent space to better represent the distribution of the data.

The computing device inputs feature data into a variational autoencoder and trains the variational autoencoder using KL divergence loss and reconstruction loss, thereby enabling the distribution of the latent variables of the trained variational autoencoder to be approximated as a Gaussian distribution. Specifically, the computing device may utilize the KL divergence metric to force the latent variables in the variational autoencoder to follow a Gaussian distribution. In this case, the KL divergence may be calculated at the batch level, rather than at the individual sample level, and the latent variables in the batch may be forced to follow a standard normal distribution. To obtain the KL divergence loss, the computing device may first define the mean and variance of the feature data.

The feature data input to the variational autoencoder is data extracted from the input batch data and memory buffer data by the feature extractor, and the mean and variance of the feature data are defined by Equation 1 below.

$${μ}_{{B}_{i}} = \frac{1}{\vert {B}_{i} \vert} {\sum }_{b ∈ {B}_{i}} {z}_{b} , \qquad Equation 1$$

$${σ}_{{B}_{i}}^{2} = \frac{1}{\vert {B}_{i} \vert} {\sum }_{b ∈ {B}_{i}} ( {z}_{b} - {μ}_{{B}_{i}} ) \hat{} 2$$

Here, μ_{B}_{ᵢ} represents the mean of the feature data in a batch unit,

$${σ}_{B , i}^{2}$$

represents the variance of the feature data in a batch unit, Bᵢ represents the feature data of the batch unit, b∈Bᵢ represents the sample data from the feature data of the batch unit, and z_{b} represents a latent variable of sample data

The computing device may calculate the KL divergence loss function of the feature data at the batch unit level by using the mean and variance of the feature data obtained from Equation 1, as shown in Equation 2 below.

$${L}_{K L} = - 0 \text{.5} * {\sum }_{j = 1}^{n} ( 1 + log ( {σ}_{B , j}^{2} ) - {μ}_{B , j}^{2} - {σ}_{B , j}^{2} ) \qquad Equation 2$$

Here, μ_{B,j} represents the mean of the j-th dimension in the feature data B of the batch unit,

$${σ}_{B , j}^{2}$$

represents the variance of the j-th dimension in the feature data B of the batch unit, and n represents the number of dimensions of the latent space. The number of dimensions in the latent space represents the number of features in the feature data.

By training the variational autoencoder using the KL divergence loss function of Equation 2, the distribution of latent variables in the variational autoencoder may be approximated to follow a Gaussian distribution.

The computing device may calculate a total loss function by combining the KL divergence loss function and the reconstruction loss function of the variational autoencoder. The total loss function may be calculated by Equation 7 below.

$${L}_{i} ( {θ}_{VAE} ; {B}_{i} ) = {\sum }_{b ∈ {B}_{i}} {L}_{r e c o n} ( b , {b}_{r e c o n} ) + β * {L}_{KL} \qquad Equation 7$$

Here, L_recon(b,b_{recon}) is the reconstruction loss function of the variational autoencoder. The reconstruction loss function represents the difference between input feature data (sample data) b and output data of the decoder (i.e., reconstructed data) b_{recon}, and β represents a preset hyperparameter.

The computing device may approximate the latent distribution, which is the output distribution of the encoder, as a Gaussian distribution using the variational autoencoder trained by a total loss function.

In step S130, after the latent distribution is approximated as a Gaussian distribution through the above process, the computing device can output a sigma point in the latent space of the trained variational autoencoder.

Sigma points are a method used to approximate probability distributions in nonlinear systems, and may be introduced for the purpose of approximating data distributions. In the probability distribution approximation method using sigma points, several sigma points are selected based on the mean and covariance of a given probability distribution, and these points are applied to a nonlinear function to estimate a new distribution. The use of sigma points can effectively reflect nonlinear changes in the distribution without linearizing the system, unlike the extended Kalman filter.

Sigma points represent key points in the state distribution and are selected based on the mean and covariance matrix. After applying a nonlinear transformation to these points, the mean and covariance of a new probability distribution are calculated based on the results. This allows for a more accurate reflection of the uncertainty in state variables in nonlinear systems.

In the present disclosure, the method using sigma points is employed to efficiently process and approximate nonlinear data distributions in a continuous learning environment, and may serve as a key factor in reducing errors that may occur due to nonlinearity.

In the disclosed embodiment, the sigma points may include a first sigma point corresponding to the mean of the latent distribution approximated as the Gaussian distribution, a second sigma point shifted along a particular dimension j of the covariance of the latent distribution approximated as the Gaussian distribution, and a third sigma point shifted in a direction symmetrical to the particular dimension j of the covariance of the latent distribution approximated as the Gaussian distribution.

The sigma point may be calculated using Equation 3 below.

$${χ}_{m}^{i} = {μ}_{i} , \qquad Equation 3$$

$${χ}_{j}^{i} = {μ}_{i} + {[ \sqrt{( γ + n ) {\sum }_{i}} ]}_{j} ,$$

$${χ}_{j + n}^{i} = {μ}_{i} - {[ \sqrt{( γ + n ) {\sum }_{i}} ]}_{j}$$

Here,

$${χ}_{m}^{i}$$

is the first sigma point,

$${χ}_{j}^{i} , {χ}_{j + n}^{i}$$

are the second and third sigma points, μᵢ represents the mean of the latent distribution approximated as the Gaussian distribution of the i-th feature data, Σᵢ represents the covariance of the latent distribution approximated as the Gaussian distribution of the i-th feature data, γ′ is a parameter in the range [−n, 0], n represents the number of dimensions in the distribution, and j represents an indicator representing a specific dimension in the covariance matrix.

Sigma points exist as points that contain a point corresponding to the mean of the latent distribution and pairs of two points symmetrical to the point corresponding to the mean of the latent distribution, and exist as pairs in each dimension. Therefore, ((n×2)+1) sigma points are calculated. Here, n is the number of dimensions

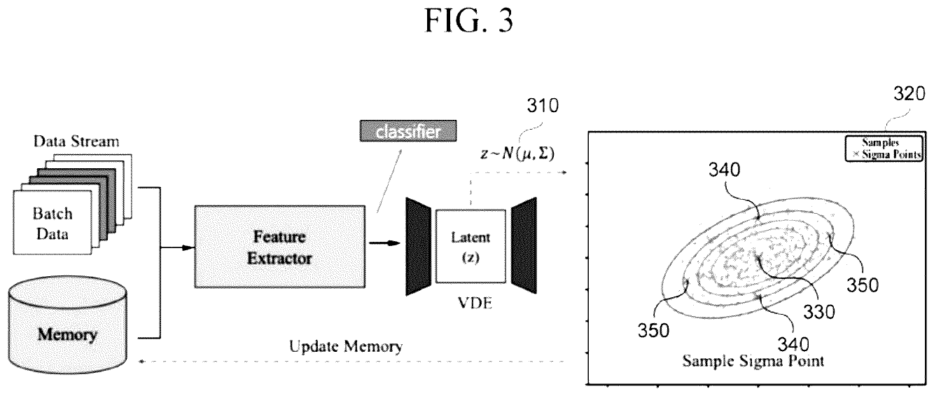

FIG. 3 is a diagram for describing the calculation of sigma points in an embodiment of the present disclosure. FIG. 3 shows an example for the case where the number of dimensions (n) is 2. An image 320 is shown where a sigma point is extracted from the distribution of the latent space 310 of a variational autoencoder trained to be approximated as a Gaussian distribution.

xₘ, which is a point 330 corresponding to the mean of the latent distribution approximated as the Gaussian distribution of the feature data,

x₁ and x₃, which are sigma points 340 in the first dimension of the covariance of the latent distribution approximated as the Gaussian distribution, and x₂ and x₄, which are sigma points 350 in the second dimension of the covariance of the latent distribution approximated as the Gaussian distribution, can each be calculated as sigma points.

In step S140, the computing device may store data (samples) closest to the calculated sigma point among the batch data in the memory buffer. Here, the data to be stored in the memory buffer may be expressed by Equations 4-6 below.

$${S}_{m}^{i} = arg {min}_{{x}_{i} ∈ ( {t}_{i} ⋃ {M}_{i} )} {‖ {χ}_{m}^{i} - {z}_{{x}_{i}} ‖}_{2} \qquad Equation 4$$

$${S}_{j}^{i} = arg {min}_{{x}_{i} ∈ ( {t}_{i} ⋃ {M}_{i} )} {‖ {χ}_{j}^{i} - {z}_{{x}_{i}} ‖}_{2} \qquad Equation 5$$

$${S}_{j + n}^{i} = arg {min}_{{x}_{i} ∈ ( {t}_{i} ⋃ {M}_{i} )} {‖ {χ}_{j + n}^{i} - {z}_{{x}_{i}} ‖}_{2} \qquad Equation 6$$

Here,

$${S}_{m}^{i} , {S}_{j}^{i} , and {S}_{j + n}^{i}$$

represent the data closest to the first sigma point, the second sigma point, and the third sigma point, respectively, zₓ_{ᵢ} represents the latent variable for the sample data of the i-th feature data, xᵢ∈(tᵢ∪Mᵢ) is data including the i-th batch data tᵢ and data Mᵢ stored in the i-th memory buffer, and xᵢ is a sample belonging to the ith batch data and the i-th memory data.

argmin is a function that returns the position of the smallest value in any list or array, and

$${‖ {χ}_{m}^{\text{?}} - {z}_{{x}_{i}} ‖}_{2}$$

$$\text{?} \text{indicates text missing or illegible when filed}$$

represents the vector distance of the latent variable for the sample data of the i-th feature data and the first sigma point, which is the mean of the latent distribution approximated as the Gaussian distribution of the i-th feature data.

The data closest to the sigma point represents the sample data closest to the sigma point defined based on the mean and covariance of the latent distribution in the latent space, and thus the selected data may be restored to the original feature data dimension through the decoder and then stored in the memory buffer.

The remaining slots in the memory buffer, where the data closest to the sigma point are stored, may be filled with sample data randomly selected from within the latent distribution.

After n-th data is stored in the memory buffer through each step of FIG. 1, an (n+1)-th step may be performed according to FIG. 2. The operation of each step of FIG. 2 will be described below.

In step S210, the computing device may receive new (n+1)-th batch data for online continuous learning.

In step S220, the computing device may input (n+1)-th batch data and n-th memory buffer data (data stored in the memory buffer among n-th batch data) to the feature extractor to extract (n+1)-th feature data.

In step S230, the computing device may input the extracted (n+1)-th feature data into a variational autoencoder to calculate a sigma point. The sigma point may be calculated using Equation 3 described above.

In step S240, the computing device may store (n+1)-th data closest to the calculated sigma point in the memory buffer.

In step S250, the computing device may input the (n+1)-th data stored in the memory buffer and newly input (n+2)-th batch data back into the feature extractor. After that, each step may be repeatedly performed.

As a result, the computing device may extract features again using newly input batch data to the feature extractor and data stored in the memory buffer, and repeat the process to perform experience replay for online continuous learning.

The core of experience replay is to help maintain memories of previous tasks while adapting to new tasks by replaying previously learned data when learning new tasks. To this end, the process of storing data in a memory buffer based on sigma points and re-inputting this data into the model to learn a new task when learning new tasks may be repeated.

Therefore, by repeatedly performing the steps of FIGS. 1 and 2, a neural network device that performs experience replay for online continuous learning based on sigma points can be trained.

In step S260, the feature data extracted by the feature extractor from the newly input batch data to the computing device and the data stored in the memory buffer may be input to a classifier to predict a class of the batch data. By applying the SoftMax function to the feature data, the output may be converted into a probability distribution to predict the class value.

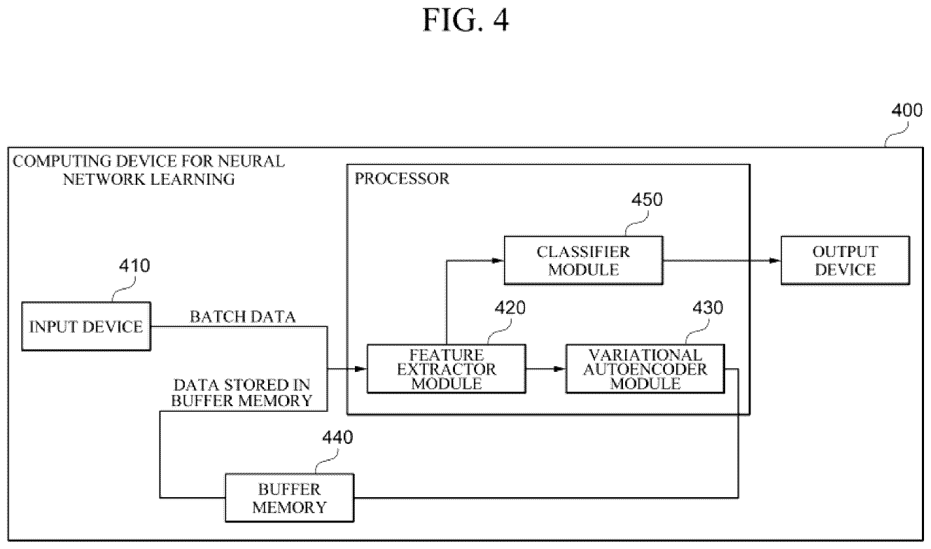

FIG. 4 is a configuration diagram of a computing device that performs neural network learning according to an embodiment of the present disclosure.

Referring to FIG. 4, a computing device 400 may include an input device 410 that can receive batch data for online continuous learning, a feature extractor module 420 that can extract features from the batch data and data stored in the memory buffer, a variational autoencoder module 430 that can calculate a sigma point from the extracted feature data, a memory buffer 440 that can store data closest to the calculated sigma point, and a classifier module 450 that can predict a class of the batch data. However, the above components 410 to 450 are merely examples of components that can be controlled by the computing device 400.

Each component in FIG. 4 can be interconnected by a communication bus. The input device 410 may be provided with various input interfaces for receiving data. In this specification, a module may mean a functional and structural combination of hardware for implementing the technical idea of the present disclosure and software for driving the hardware. For example, the above “module” may mean a logical unit of a given code and hardware resources for executing the given code, and does not necessarily mean physically connected code or a single type of hardware.

Meanwhile, performance verification can be conducted on the trained neural network model. The dataset used for performance verification was Split-CIFAR-100, which is obtained by splitting the CIFAR-100 dataset, which consists of 100 classes, into 10 tasks, each task containing 10 classes. This dataset is trained sequentially, and each task is processed in a continuous learning environment. In particular, task identity is not provided during learning between tasks, which is designed to ensure that the model only performs one epoch of learning without revisiting each task.

In online continuous learning, the model learns data provided once and then operates in a continuous learning environment without seeing the data again. Data for each task is processed at once, and the model does not recognize its characteristics between task transitions. This approach aims to ensure continuous learning is possible in real-world environments. In addition, in the present disclosure, learning is performed using a scaled-down ResNet-18 model, the input batch size is set to 32, and the batch size for sample extraction from the memory buffer is set to 45. This setting optimizes sample extraction from the memory buffer, aiming to balance model performance and memory usage.

Performance evaluation was conducted by comparing the experience replay (ER) method with the method using the present disclosure.

ER (Basic Method): The average accuracy AAA was measured as 20.05, and the final accuracy was measured as 15.95.

The present disclosure: The average accuracy AAA was measured as 17.38, and the final accuracy was measured as 14.04.

The experimental results of the present disclosure demonstrate that the method of the present disclosure, which performs experience replay using sigma points, achieves higher performance than the ER method based on a random buffer. In particular, it can be confirmed that the present disclosure achieves performance improvement by performing more sophisticated sampling based on sigma points compared to ER using random buffer sampling.

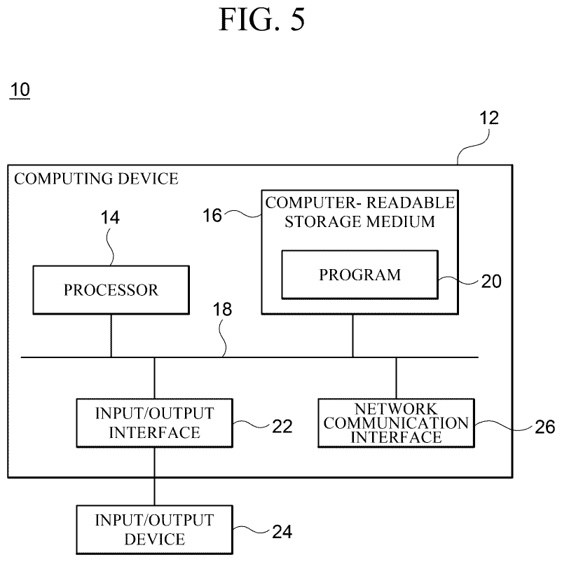

FIG. 5 is a block diagram for illustrating a computing environment 10 including a computing device suitable for use in exemplary embodiments. In the illustrated embodiment, respective components may have different functions and capabilities other than those described below, and include additional components in addition to those described below.

The illustrated computing environment 10 includes a computing device 12. In an embodiment, the computing device 12 may be a computing device for performing online continuous learning on a neural network. That is, the computing device 12 may be a device for performing the embodiments of the invention described above. For example, the computing device 12 may be the computing device 400 illustrated in FIG. 4.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

In an embodiment, sigma points are calculated based on the mean and covariance of the data and focus on preserving the distribution information of the data unlike random sampling methods. This method allows the overall data distribution to be well reflected even with a small number of samples, thereby allowing the model to efficiently use previous information when learning from both new and past data. In particular, even in situations where memory resources are limited, the sigma point method can efficiently utilize memory resources by using less data. Furthermore, the memory buffer constructed through sigma points does not distort the data distribution, thereby helping the model process new data without losing important information about past data. This enables the model to undergo more sophisticated training, prevent overfitting even when dealing with complex data distributions and maintain more balanced performance.

The above description of the present disclosure is for illustrative purposes only, and a person having ordinary skill in the art to which the present disclosure pertains will understand that the present disclosure can be easily modified into other specific forms without altering the technical idea or essential characteristics of the present disclosure. Therefore, it should be understood that the embodiments described above are exemplary in all respects and not as limiting. For example, each component described as a single entity may be implemented in a distributed manner, and similarly, components described as distributed may be implemented in a combined form.

The scope of the present disclosure is defined by the claims described below rather than the detailed description above, and all modifications or variations derived from the meaning and scope of the claims and their equivalent concepts should be interpreted as being included in the scope of the present disclosure.

What is claimed is:

1. A neural network learning method performed on a computing device including one or more processors, a memory that stores one or more programs executed by the one or more processors, and a neural network for online continuous learning, the neural network learning method comprising:
receiving n-th batch data for the online continuous learning;
inputting the received n-th batch data into a feature extractor to extract n-th feature data;
calculating a sigma point for the extracted n-th feature data in a latent space by inputting the n-th feature data into a variational autoencoder; and
storing data closest to the sigma point calculated from the n-th feature data in a memory buffer.

2. The neural network learning method of claim 1, further comprising:
inputting n-th data stored in the memory buffer and (n+1)-th batch data into the feature extractor to extract (n+1)-th feature data;
calculating a sigma point for the (n+1)-th feature data in the latent space by inputting the (n+1)-th feature data into the variational autoencoder; and
storing data corresponding to the sigma point calculated from the (n+1)-th feature data in the memory buffer.

3. The neural network learning method of claim 2, further comprising inputting n-th data stored in the memory buffer and (n+1)-th batch data input into the feature extractor to extract (n+1)-th feature data, and then inputting the (n+1)-th feature data into a classifier to predict a class of the (n+1)-th batch data.

4. The neural network learning method of claim 1, wherein the calculating of the sigma point includes training the variational autoencoder, and
in the training of the variational autoencoder, the variational auto-encoder is trained by a preset loss function that allows a distribution of a latent variable of the variational auto-encoder for the feature data to be approximated as a Gaussian distribution.

5. The neural network learning method of claim 4, wherein the loss function is set by a reconstruction loss function of the variational autoencoder and a KL divergence loss function based on a mean and variance of the feature data.

6. The neural network learning method of claim 5, wherein the KL divergence loss function is expressed by Equation 1:
$${L}_{K L} = - 0 \text{.5} * {\sum }_{j = 1}^{n} ( 1 + log ( {σ}_{B , j}^{2} ) - {μ}_{B , j}^{2} - {σ}_{B , j}^{2} ) \qquad [ Equation l ]$$
where μ_{B,j} is a mean of j-th dimension of feature data in batch unit;
$${σ}_{B , j}^{2}$$
is a variance of j-th dimension of feature data in batch unit;
n is the number of dimensions in latent space; and
j is an indicator representing specific dimension in covariance matrix.

7. The neural network learning method of claim 6, wherein the loss function is expressed by Equation 2:
$${L}_{i} ( {θ}_{V A E} ; {B}_{i} ) = {\sum }_{b ∈ {B}_{i}} {L}_{r e c o n} ( b , {b}_{r e c o n} ) + β * {L}_{K L} \qquad [ Equation 2 ]$$
where Bᵢ is batch data;
b is sample data belonging to batch data;
L_recon(b,b_{recon}) is a reconstruction loss;
β is a hyperparameter; and
L_{KL} is a KL divergence loss function.

8. The neural network learning method of claim 4, wherein the sigma point includes a first sigma point calculated using the mean of the latent space distribution approximated as the Gaussian distribution, and a second sigma point and a third sigma point each calculated using the mean and covariance of the latent space distribution approximated as the Gaussian distribution.

9. The neural network learning method of claim 8, wherein the first sigma point to the third sigma point are calculated using Equation 3:
$${χ}_{m}^{i} = {μ}_{i} , {χ}_{j}^{i} = {μ}_{i} + {[ \sqrt{( γ + n ) {\sum }_{i}} ]}_{j} , {χ}_{j + n}^{i} = {μ}_{i} - {[ \sqrt{( γ + n ) {\sum }_{i}} ]}_{j} \qquad [ Equation 3 ]$$
where
$${χ}_{m}^{i}$$
is a first sigma point;
$${X}_{j}^{i}$$
is a second sigma point;
$${X}_{j + n}^{i}$$
is a third sigma point;
j is an indicator indicating specific dimension in covariance matrix;
n is a total number of dimensions in latent distribution;
μᵢ is a mean of latent space distribution approximated as Gaussian distribution;
Σᵢ is a covariance of latent space distribution approximated as Gaussian distribution; and
γ is a pre-set hyperparameter.

10. The neural network learning method of claim 9, wherein, in the storing of the data closest to the sigma point in the memory buffer, data respectively closest to the first sigma point to the third sigma point among the batch data is extracted and stored in the memory buffer.

11. The neural network learning method of claim 10, wherein the data to be stored in the memory buffer is extracted using Equations 4-6:
$${S}_{m}^{i} = arg {min}_{{x}_{i} ∈ ( {t}_{i} ⋃ {M}_{i} )} {‖ {χ}_{m}^{i} - {z}_{{x}_{i}} ‖}_{2} \qquad [ Equation 4 ]$$
$${S}_{j}^{i} = arg {min}_{{x}_{i} ∈ ( {t}_{i} ⋃ {M}_{i} )} {‖ {χ}_{j}^{i} - {z}_{{x}_{i}} ‖}_{2} \qquad [ Equation 5 ]$$
$${S}_{j + n}^{i} = arg {min}_{{x}_{i} ∈ ( {t}_{i} ⋃ {M}_{i} )} {‖ {χ}_{j + n}^{i} - {z}_{{x}_{i}} ‖}_{2} \qquad [ Equation 6 ]$$
where
$${S}_{m}^{i}$$
is data closest to first sigma point among batch data;
$${S}_{j}^{i}$$
is data closest to second sigma point among batch data;
$${S}_{j + n}^{i}$$
is data closest to third sigma point among batch data;
zₓ_{ᵢ} is a latent variable of data xᵢ; and
argmin is a function that returns position of the smallest value in list or array.

12. A computing device comprising:
a processor;
a memory that stores one or more programs executed by the processor; and
a neural network for online continuous learning,
wherein the processor is configured to perform:
an operation of receiving n-th batch data for the online continuous learning;
an operation of inputting the received n-th batch data into a feature extractor to extract n-th feature data;
an operation of calculating a sigma point for the extracted n-th feature data in a latent space by inputting the n-th feature data into a variational autoencoder; and
an operation of storing data closest to the sigma point calculated from the n-th feature data in a memory buffer.

13. The computing device of claim 12, wherein the processor is configured to perform:
an operation of inputting n-th data stored in the memory buffer and (n+1)-th batch data into the feature extractor to extract (n+1)-th feature data;
an operation of calculating a sigma point for the (n+1)-th feature data in the latent space by inputting the (n+1)-th feature data into the variational autoencoder; and
an operation of storing data corresponding to the sigma point calculated from the (n+1)-th feature data in the memory buffer.

14. The computing device of claim 12, wherein the processor is configured to perform:
an operation of inputting n-th data stored in the memory buffer and (n+1)-th batch data input into the feature extractor to extract (n+1)-th feature data; and
an operation of inputting the (n+1)-th feature data into a classifier to predict a class of the (n+1)-th batch data.

15. The computing device of claim 12, wherein the operation of calculating the sigma point includes an operation of training the variational autoencoder, and
in the training of the variational autoencoder, the variational auto-encoder is trained by a preset loss function that allows a distribution of a latent variable of the variational auto-encoder for the feature data to be approximated as a Gaussian distribution.

16. The computing device of claim 15, wherein the loss function is set by a reconstruction loss function of the variational autoencoder and a KL divergence loss function based on a mean and variance of the feature data.

17. The computing device of claim 15, wherein the sigma point includes a first sigma point calculated using the mean of the latent space distribution approximated as the Gaussian distribution, and a second sigma point and a third sigma point each calculated using the mean and covariance of the latent space distribution approximated as the Gaussian distribution.

18. The computing device of claim 17, wherein, in the operation of storing the data closest to the sigma point in the memory buffer, data respectively closest to the first sigma point to the third sigma point among the batch data is extracted and stored in the memory buffer.

19. A computer program stored in a non-transitory computer readable storage medium, wherein the computer program includes one or more instructions, and the instructions, when executed by a computing device including one or more processors, cause the computing device to perform:
receiving n-th batch data for the online continuous learning;
inputting the received n-th batch data into a feature extractor to extract n-th feature data;
calculating a sigma point for the extracted n-th feature data in a latent space by inputting the n-th feature data into a variational autoencoder; and
storing data closest to the sigma point calculated from the n-th feature data in a memory buffer.
